(19) United States
(12) Patent Application Publication
(10) Pub. No.: US 2007/0060054 A1
(43) Pub. Date: Mar. 15, 2007

(54) Wireless home communication system method and apparatus

(75) Inventor: Eric D. Romesburg, Chapel Hill, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/227,373

(22) Filed: Sep. 15, 2005

(51) Int. Cl. H04Q 7/20

(52) U.S. Cl. 455/41.2; 455/41.3

(57) ABSTRACT

A method and apparatus for interfacing a television with a cellular telephone during wireless voice communication sessions is described herein. According to an exemplary embodiment, the television operates as a hands-free interface for the cellular telephone during communication sessions. In one embodiment, the television receives a call notification from the cellular telephone over a short-range wireless interface. Responsive to this call notification, the television controls at least one of an audio output and a video output to notify the user of the incoming call. When the user activates a control button associated with the television, the wireless network establishes a voice communication session. During the voice communication session, the cellular telephone routes call audio signals between the television and the wireless network.

### BACKGROUND

This invention relates generally to wireless communications in a wireless network, and more particularly to a mobile communication device that interoperates with a home theater device.

Due to the popularity of cellular telephones, individuals often use their cellular telephone as their primary communication device, even when they are at home. However, when the phone rings due to an incoming call, a cellular telephone may be located anywhere within the home. If a user is not close enough to the phone, users may miss the incoming call because they cannot hear the ring tones. In addition, while watching television, the volume of the television may prevent the user from hearing the ring tones associated with an incoming call.

Further, cellular telephones are often uncomfortable to use for long conversations. To address this, some cellular telephones include hands-free capabilities, i.e., speaker phone capabilities. However, due to the size of the speaker used by cellular telephones, the quality of the audio signals exchanged while using the cellular telephone as a speaker phone is limited.

### SUMMARY

The present invention addresses at least some of these problems by using a home theater device, such as a television, as a hands-free interface for the mobile communication device. According to one embodiment, a short-range wireless transceiver in the home theater device exchanges call signals with the mobile communication device. Responsive to these call signals, a controller in the home theater device controls at least one of an audio output and a video output of the home theater device.

In one exemplary embodiment, the call signals may comprise call control signals, such as a received call notification at the mobile communication device. The mobile communication device routes the received call notification to the home theater device via a short-range wireless transceiver. Responsive to the received call notification, the home theater device controls at least one of an audio output and a video output of the home theater device to notify the user of the incoming call. For example, the home theater device may display a video message and/or generate an audible ring tone responsive to the notification signal. As a result, the user receives notification of an incoming call even when the distance to the mobile communication device and/or the volume of the home theater device prevents the user from hearing the mobile communication device.

Once the user receives notification of the incoming call, the user answers the call by generating call initiation response signals using either the mobile communication device or the home theater device. When the user answers the call using the mobile communication device, the wireless network establishes a voice communication session between the mobile communication device and the wireless network. To answer the call using the home theater device, the user provides input to the home theater device. The mobile communication device then routes call signals, such as call audio signals and/or call video signals, between the home theater device and the wireless network to establish a hands-free voice communication session between the home theater device and the wireless network.

According to another exemplary embodiment, the call signals may comprise call initiation request signals generated responsive to user input. In this embodiment, the user places an outgoing call by providing contact information, such as a phone number, to the home theater device. The home theater device then generates call initiation request signals based on the provided contact information, and provides the call initiation request signals to the mobile communication device via the short-range wireless transceiver, causing the mobile communication device to place the call with the wireless network. After the call is connected, the mobile communication device routes call signals, such as call audio signals and/or call video signals, between the home theater device and the wireless network to establish a hands-free voice communication session between the home theater device and the wireless network.

### BRIEF DESCRIPTION OF THE DRAWINGS

FIG. 1 illustrates a wireless system according to one exemplary embodiment of the present invention.

FIG. 2 illustrates a block diagram of one exemplary mobile communication device in the wireless system of FIG. 1.

FIG. 3 illustrates a block diagram of one exemplary video device in the wireless system of FIG. 1.

FIG. 4 illustrates a process diagram for one embodiment of the present invention.

FIGS. 5A-5C illustrate process diagrams for one embodiment of the present invention.

FIGS. 6A-6C illustrate process diagrams for another embodiment of the present invention.

FIGS. 7A-7C illustrate process diagrams for another embodiment of the present invention.

### DETAILED DESCRIPTION

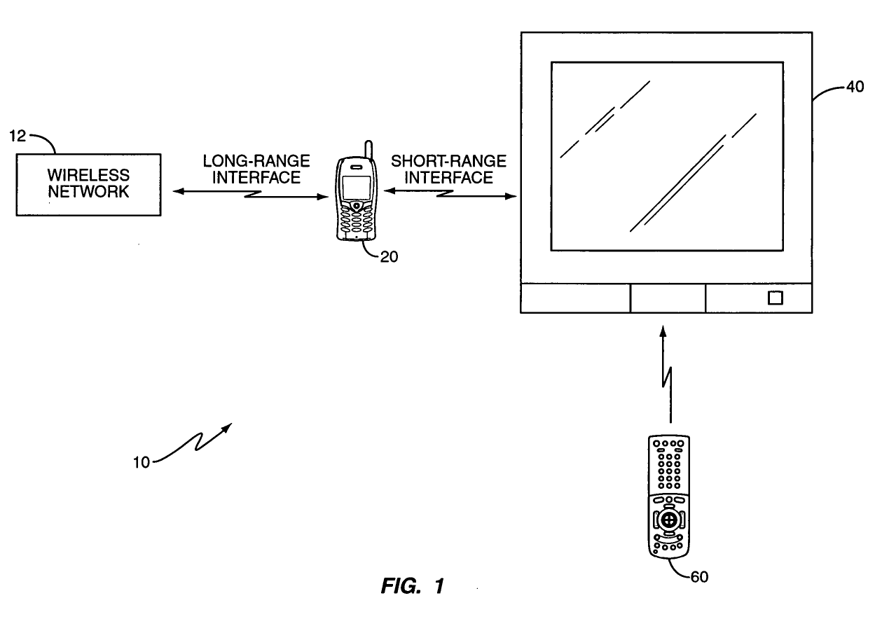

FIG. 1 illustrates an exemplary wireless system 10 for the present invention. Wireless system 10 includes a wireless network 12, at least one cellular telephone 20, a television 40, and an optional remote control 60 for the television 40. Cellular telephone 20 communicates with wireless network 12 over a long-range wireless interface according to any known wireless standard. For example, cellular telephone 20 may communicate with wireless network 12 using CDMA (Code Division Multiple Access), TDMA (Time Division Multiple Access), GSM (Global System for Mobile communications), WCDMA, (Wideband CDMA), FDMA (Frequency Division Multiple Access), etc. In addition, cellular telephone 20 communicates with television 40 over any known short-range wireless interface, i.e., an infra-red interface, a Bluetooth® interface, 802.11 interface, etc.

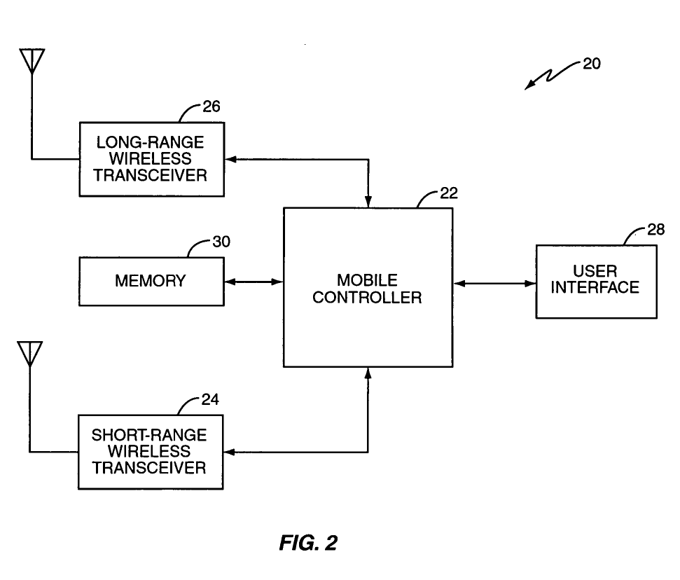

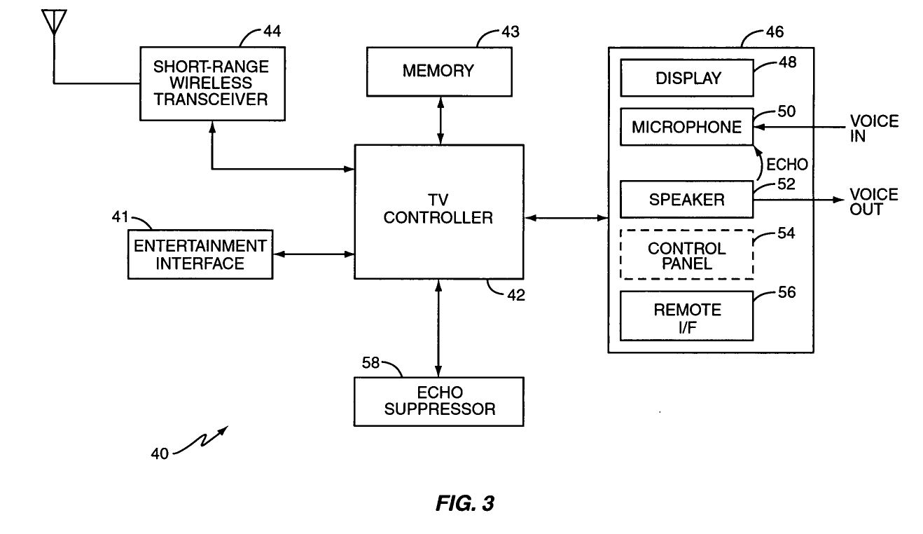

FIGS. 2 and 3 illustrate an exemplary cellular telephone 20 and television 40, respectively, according to the present invention. As shown in FIG. 2, cellular telephone 20 includes a mobile controller 22, a short-range wireless transceiver 24, a long-range wireless transceiver 26, a user interface 28, and memory 30. Short-range wireless transceiver 24 interfaces the cellular telephone 20 with a remote home theater device, such as television 40, while long-range wireless transceiver 26 interfaces the cellular telephone 20 with the wireless network 26, as discussed above. Mobile controller 22 controls the operation of cellular telephone 20 responsive to programs stored in memory 30 and instructions provided by the user via user interface 28. In addition, mobile controller 22 is configured to control the operation of the cellular telephone 20 responsive to signals received from the television 40 and responsive to signals received from the wireless network 12 for the television 40, as discussed further below.

As shown in FIG. 3, television 40 includes an entertainment interface 41, such as a cable interface, DVD player interface, etc., a television controller 42, memory 43, a short-range wireless transceiver 44, a user interface 46, and an echo suppressor 58. User interface 46 comprises a display 48 for displaying video programming to the user, a speaker 52 for providing audio content to the user, and an optional control panel 54 on the housing of television 40 to control some television functions, such as channel, volume, power, etc. In addition, user interface 46 may include a remote control interface 56 that interfaces television 40 with a remote control 60, as well understood in the art. The user interface 46 may also include a microphone 50, as discussed further below.

Television controller 42 controls the operations of the television 40 responsive to programs stored in memory 43 and instructions provided by the user via the user interface 46. In addition, television controller 42 is configured to control the audio output, video output, and/or microphone output of the television 40 responsive to signals received from the cellular telephone 20 at short-range wireless transceiver 44, as discussed further below.

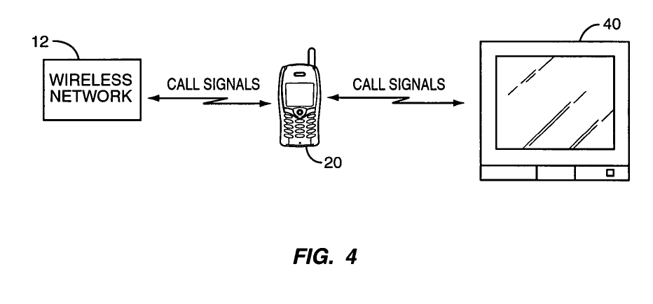

According to one exemplary embodiment, shown in FIG. 4, television 40 operates as a hands-free interface between the user and the cellular telephone 20. Accordingly, television 40 exchanges call signals with the cellular telephone 20, and television controller 42 controls the audio output and/or the video output of television 40 responsive to call signals received from the cellular telephone 20. As used herein, call signals may include any call control signals and/or call audio/video signals associated with a wireless communication.

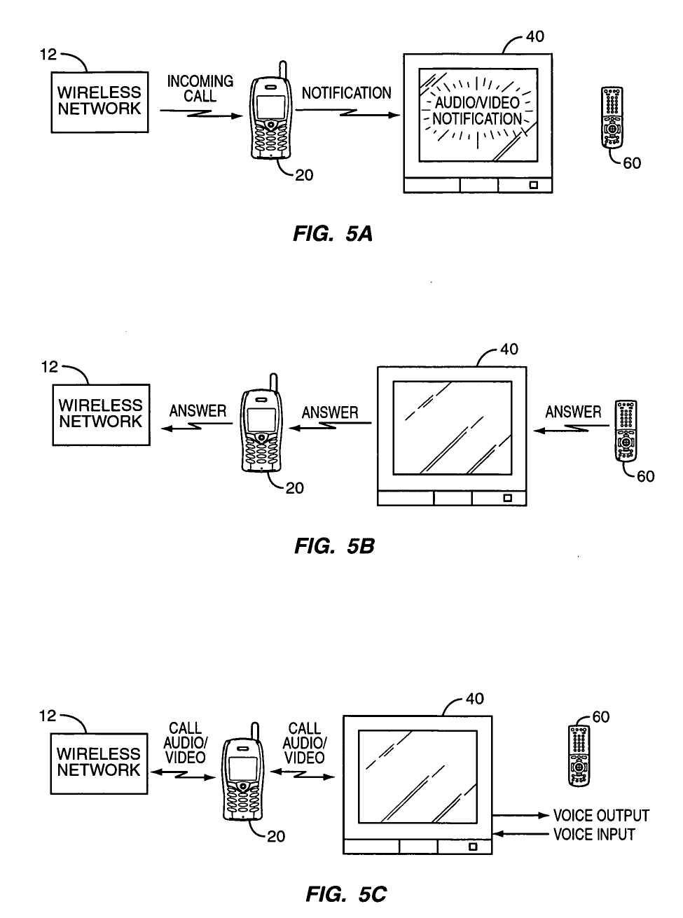

According to another exemplary embodiment, television 40 operates as an extension of cellular telephone 20 to notify a user of an incoming call from a remote party. More particularly, as shown in FIG. 5A, when wireless network 12 notifies the cellular telephone 20 of an incoming call, cellular telephone 20 generates and sends a call control signal, i.e., a received call notification, to television 40. Responsive to the received call notification, television 40 controls the audio output and/or video output of television 40 to notify the user of the incoming call.

To answer the call, the user sends another call control signal, such as a call initiation response signal, to cellular telephone 20 by providing an input to television 40 via control panel 54 or remote control 60. Cellular telephone 20 forwards the call initiation response signal to wireless network 12 via the long-range wireless transceiver 26, as shown in FIG. 5B. Responsive to the call initiation response signal, wireless network 12 establishes a voice communication session. After the wireless network 12 establishes the voice communication session, the cellular telephone 20 routes call audio signals and/or call video signals between the television 40 and the wireless network 12, as shown in FIG. 5C. The following describes further details of the notification, answer, and voice communication session processes of the present invention.

As discussed above, television controller 42 controls the audio and/or video output of television 40 responsive to the received call notification. In one embodiment, the television controller 42 controls the output of display 48 to display a video notification signal responsive to the received call notification. The video notification signal may comprise any type of video signal that notifies the user of an incoming call, including a text message, an icon image, etc. Television controller 42 may control display 48 to interrupt the current video output to display the video notification signal. Alternatively, television controller 42 may overlap the video notification signal with the current video output by displaying the video notification signal on a small portion of display 48, such as along a bottom of the display 48 or in a corner of the display 48.

The television controller 42 may alternatively or additionally control the output of speaker 52 to produce an audio notification signal responsive to the received call notification. The audio notification signal may comprise any type of audio signal generated by the television or the network that notifies the user of an incoming call, including a ring tone, audio announcement, etc. In addition, the television controller 42 may reduce the volume and/or mute the audio output of the television programming to better enable the user to hear the audio notification signal.

A user may respond to the audio/video notification output by providing input to the television 40 through the remote control 60. For example, the user may activate a control button on remote control 60 to answer the call. Alternatively, the user may activate a control button to ignore the incoming call and therefore stop the audio/video notification. Remote control 60 may include specific control buttons, e.g., answer, hang-up, ignore, etc., for the telephone feature of the present invention. Alternatively, conventional control buttons on remote control 60 may be programmed to implement specific functions based on the operating mode of the television 40. For example, the control buttons in a remote control number keypad may change the channel when television 40 is in a television mode, and may function as phone control buttons when the television 40 is in a phone mode. While the above describes using a remote control 60 to respond to an incoming call, it will be appreciated that the user may alternatively use control panel 54.

When the user responds to the notification, television controller 42 cancels the audio/video notification output and sends a call initiation response signal to the cellular telephone 20. In response, mobile controller 22 sends the call initiation response signal to the wireless network 12 to establish a voice communication session with the remote party. During the voice communication session, mobile controller 22 routes call audio signals between the wireless network 12 and television 40 via short-range wireless transceivers 24, 44. In response, television controller 42 processes the received call audio signals and sends the processed signals to speaker 52 to produce voice output from the remote party to the user. Further, the user provides voice input to microphone 50 in television 40. Television controller 42 processes the voice input and sends it to cellular telephone 20 via short-range wireless transceiver 44. As such, television 40 provides hands-free voice communication during the voice communication session. While not explicitly discussed above, it will be appreciated that the cellular telephone 20 may also route call video signals between the wireless network 12 and the television 40 during the hands-free communication session.

Because microphone 50 may pick up speaker output signals in addition to the voice input signals, the output from microphone 50 may include undesirable echo signals. As such, television 40 may include an echo suppressor 58 to suppress the echo signals from the microphone output before the television controller 42 sends the microphone output signals to cellular telephone 20. Echo suppressor 58 may suppress echo from the microphone output according to any known means. Because the echo suppression is well known, it will not be discussed further herein. However, it will be appreciated that television 40 may use echo suppressor 58 whenever the television 40 is operating as a hands-free interface for the cellular telephone 20.

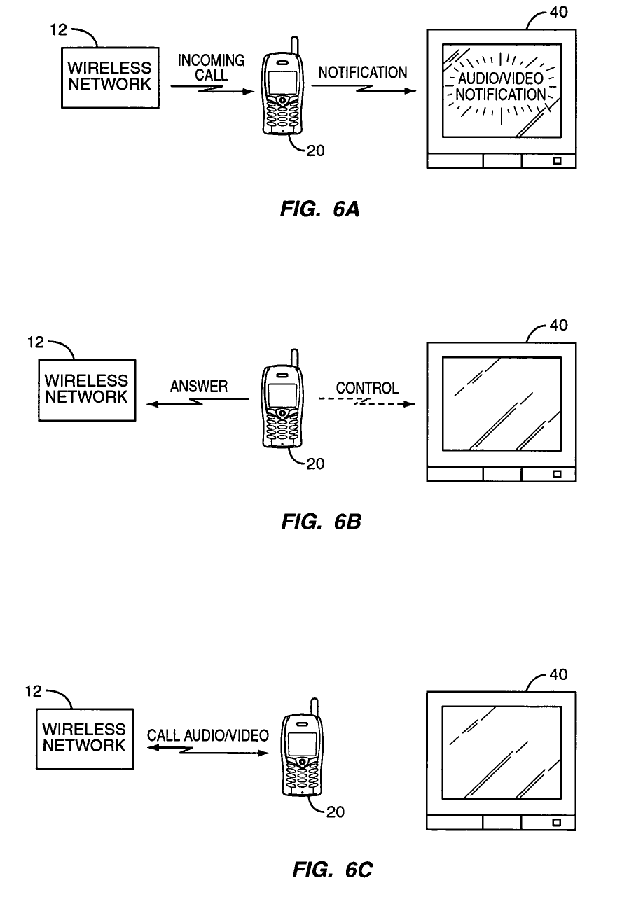

According to another exemplary embodiment, the user may answer the incoming call using the cellular telephone 20 instead of television 40. For this embodiment, cellular telephone 20 still uses the television 40 to notify a user of an incoming call from a remote party, as shown in FIG. 6A. However, according to this embodiment, the user answers the incoming call by providing input directly to cellular telephone 20. In response to the user input, cellular telephone 20 generates a call initiation response signal and transmits the call initiation response signal to the wireless network 12 via the long-range wireless transceiver 26. In addition, cellular telephone 20 may send a call control signal to the television 40 to further control the audio and/or video output of television 40, as shown in FIG. 6B. After the wireless network 12 establishes a voice communication session between the user and the remote party, the cellular telephone 20 exchanges call audio signals with the wireless network 12, as shown in FIG. 6C.

As mentioned above, cellular telephone 20 may further control the audio output of television 40 during the voice communication session. For example, after generating the call initiation response signal, mobile controller 22 may send a call control signal to television controller 42 to lower or mute the volume of the television 40, to pause the video programming during the call, and/or to turn the television 40 off. The call control signal may also resume the original output of the speaker 52 and the display 48 to allow other viewers to continue to enjoy the video program while the user takes the call. Alternatively, television controller 42 may independently control the audio output based on pre-configured settings.

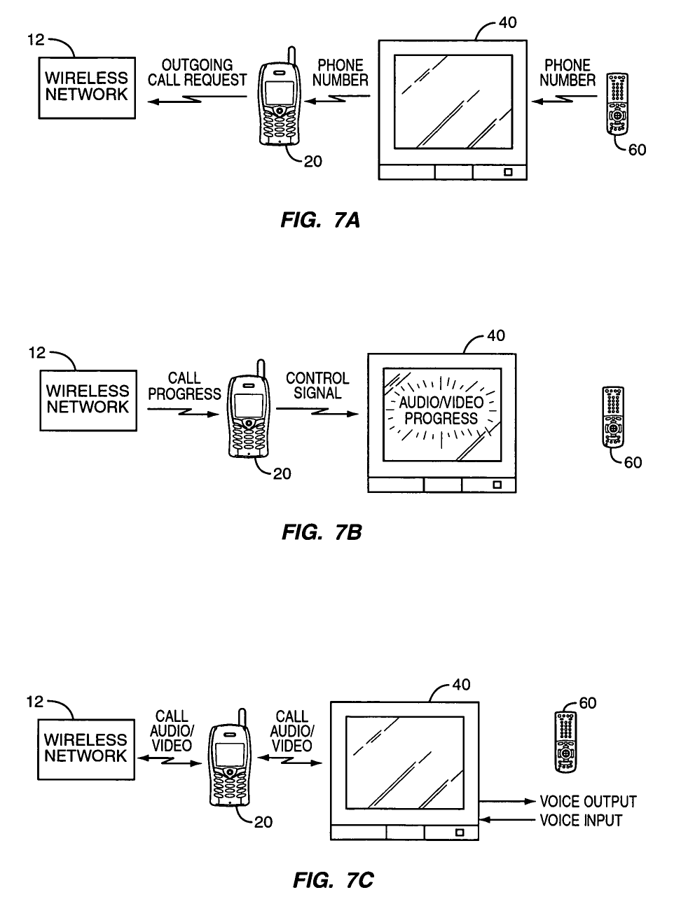

The above discusses interfacing the cellular telephone 20 with the television 40 for incoming calls from wireless network 12. However, the present invention also applies for outgoing calls, as shown in FIGS. 7A-7C. According to this embodiment, a user requests a voice communication session over the wireless network 12 via television 40. After the wireless network 12 establishes the requested voice communication session, mobile controller 22 routes call audio signals between the television 40 and the wireless network 12, as discussed above.

In particular, the user may use remote control 60 to provide outgoing call information, such as a phone number, a name, etc., to television 40. The user may also use remote control 60 to retrieve outgoing call information from a memory in television 40 or from a memory in cellular telephone 20. In any event, television controller 42 generates a call initiation request signal responsive to the outgoing call information provided to the television input, and forwards the call initiation request signal to cellular telephone 20 via short-range wireless transceiver 44. In response, mobile controller 22 in cellular telephone 20 sends the call initiation request signal to wireless network 12 via long-range wireless transceiver 26, as shown in FIG. 7A. In response, the wireless network 12 transmits a call progress signal, i.e., a ring back signal, a busy signal, etc., to cellular telephone 20. Mobile controller 22 generates a call control signal based on the received call progress signal and sends the call control signal to television 40, as shown in FIG. 7B. Television controller 42 then controls the audio output responsive to the received control signal. For example, television controller 42 may control the audio output to produce a ring back tone at the speaker 52. If the remote party answers the call, wireless network 12 establishes a hands-free voice communication session, and mobile controller 22 routes call audio signals between the wireless network 12 and television 40, as discussed above and shown in FIG. 7C. To reduce echo in the microphone output, this hands-free voice communication session may also use echo suppressor 58.

The above describes using a television 40 as an interface between a user and a cellular telephone 20. This type of interface enables a user to receive call notification even if the user cannot hear or see notification produced by cellular telephone 20. Further, it enables the user to make and receive phone calls using a television 40 as a hands-free communication device. Further still, this type of interface enables the user to use the television 40 as a speaker phone for hands-free communication regardless of how a call is initiated.

In addition, while the above only describes that the television 40 provides and receives voice output and input during the voice communication session, the present invention is not so limited. For example, display 48 may provide additional call or cellular telephone information to the user, such as cellular telephone battery level, signal reception, time, etc. Further, during the voice communication session, the user may control the volume of the voice output using the volume controls on control panel 54 or remote control 60. Further still, it will be appreciated that the cellular telephone 20 may also or alternatively route call video signals between the wireless network 12 and the television 40 during hands-free communication sessions.

While the above describes the present invention in terms of a television 40 and a cellular telephone 20, those skilled in the art will appreciate that the present invention applies to any mobile communication device and home theater device. For example, the present invention may apply to personal data assistants, pagers, or other mobile communication device. Further, the present invention applies to personal computers, portable DVD players, home theater systems, or other home theater devices.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

We claim:

1. A home theater device comprising:
an input device;
a short-range wireless transceiver configured to exchange call signals with an external mobile communication device in a wireless network; and
a controller operatively connected to the short-range wireless transceiver, said controller configured to control at least one of an audio output and a video output of the home theater device responsive to received call signals.

2. The home theater device of claim 1 wherein the call signals comprise call audio signals, and wherein the controller is configured to control at least one of the audio output and the video output of the home theater device responsive to the call audio signals exchanged between the home theater device and the mobile communication device during a hands-free voice communication session between the home theater device and the wireless network.

3. The home theater device of claim 2 further comprising an echo suppression circuit configured to suppress echo from a microphone input signal of the home theater device during the hands-free voice communication session.

4. The home theater device of claim 1 wherein the call signals comprise call video signals, and wherein the controller is configured to control at least one of the audio output and the video output of the home theater device responsive to the call video signals exchanged between the home theater device and the mobile communication device during a hands-free voice communication session between the home theater device and the wireless network.

5. The home theater device of claim 1 wherein the call signals include call control signals.

6. The home theater device of claim 5 wherein the call control signals comprise a received call notification from the mobile communication device at the short-range wireless transceiver.

7. The home theater device of claim 6 wherein the call control signals comprise call initiation response signals generated responsive to user input at the input device responsive to the received call notification, and wherein the short-range wireless transceiver is configured to send the call initiation response signals to the mobile communication device.

8. The home theater device of claim 7 wherein the call signals comprise call audio signals, and wherein the controller is configured to control at least one of the audio output and the video output of the home theater device responsive to the call audio signals exchanged between the home theater device and the mobile communication device during a hands-free voice communication session between the home theater device and the wireless network.

9. The home theater device or claim 8 further comprising an echo suppression circuit configured to suppress echo from a microphone input signal of the home theater device during the hands-free voice communication session.

10. The home theater device of claim 7 wherein the call signals comprise call video signals, and wherein the controller is configured to control at least one of the audio output and the video output of the home theater device responsive to the call video signals exchanged between the home theater device and the mobile communication device during a hands-free voice communication session between the home theater device and the wireless network.

11. The home theater device of claim 6 wherein the call control signals comprise call initiation response signals received from the mobile communication device via the short-range wireless transceiver responsive to user input at the mobile communication device, and wherein the controller is configured to control at least one of the audio output and the video output responsive to the received call initiation response signals.

12. The home theater device of claim 11 wherein the controller is configured to continue to control at least one of the audio output and the video output during a voice communication session between the mobile communication device and the wireless network.

13. The home theater device of claim 11 wherein the controller controls at least one of the audio and video outputs of the home theater device by muting the home theater device, reducing the volume of the home theater device, pausing a program on the home theater device, or turning off the home theater device.

14. The home theater device of claim 5 wherein the call control signals comprise call initiation requests generated responsive to user input, and wherein the short-range wireless transceiver is configured to send the call initiation requests to the mobile communication device.

15. The home theater device of claim 14 wherein the call control signals comprise call progress signals received from the mobile communication device via the short-range wireless transceiver, and wherein the controller is configured to control at least one of the audio output and the video output of the home theater device responsive to the received call progress signals.

16. The home theater device of claim 14 wherein the call signals comprise call audio signals, and wherein the controller is configured to control at least one of the audio output and the video output of the home theater device responsive to the call audio signals exchanged between the home theater device and the mobile communication device during a hands-free voice communication session between the home theater device and the wireless network.

17. The home theater device or claim 16 further comprising an echo suppression circuit configured to suppress echo from a microphone input signal of the home theater device during the hands-free voice communication session.

18. The home theater device of claim 14 wherein the call signals comprise call video signals, and wherein the controller is configured to control at least one of the audio output and the video output of the home theater device responsive to the call video signals exchanged between the home theater device and the mobile communication device during a hands-free voice communication session between the home theater device and the wireless network.

19. The home theater device of claim 1 wherein the input device comprises at least one of a control panel on the home theater device and a remote control device external from the home theater device.

20. The home theater device of claim 1 wherein the home theater device comprises a television.

21. The home theater device of claim 1 wherein the controller is configured to control at least one of a volume of the home theater device, a power of the home theater device, and a program displayed on the home theater device responsive to the received call signals.

22. The home theater device of claim 1 wherein the mobile communication device comprises a cellular telephone.

23. A method of interfacing a home theater device and an external mobile communication device in a wireless network, the method comprising:
exchanging call signals with the mobile communication device via a short-range wireless transceiver of the home theater device; and
controlling at least one of an audio output and a video output of the home theater device responsive to received call signals.

24. The method of claim 23 wherein the call signals comprise call audio signals, and wherein the controlling step comprises controlling at least one of the audio output and the video output of the home theater device responsive to the call audio signals exchanged between the home theater device and the mobile communication device during a hands-free voice communication session between the home theater device and the wireless network.

25. The method of claim 24 further comprising suppressing echo from a microphone input signal of the home theater device during the hands-free voice communication session.

26. The method of claim 23 wherein the call signals comprise call video signals, and wherein the controlling step comprises controlling at least one of the audio output and the video output of the home theater device responsive to the call video signals exchanged between the home theater device and the mobile communication device during a hands-free voice communication session between the home theater device and the wireless network.

27. The method of claim 23 wherein the call signals include call control signals.

28. The method of claim 27 wherein the call control signals comprise a received call notification from the mobile communication device at the short-range wireless transceiver, and wherein the controlling step comprises controlling at least one of the audio output and the video output of the home theater device responsive to the received call notification.

29. The method of claim 28 wherein the call control signals comprise call initiation response signals generated responsive to input received at an input device of the home theater device responsive to the received call notification.

30. The method of claim 29 wherein the call signals comprise call audio signals, and wherein the controlling step comprises controlling at least one of the audio output and the video output of the home theater device responsive to the call audio signals exchanged between the home theater device and the mobile communication device during a hands-free voice communication session between the home theater device and the wireless network.

31. The method of claim 30 further comprising suppressing echo from a microphone input signal of the home theater device during the hands-free voice communication session.

32. The method of claim 29 wherein the call signals comprise call video signals, and wherein the controlling step comprises controlling at least one of the audio output and the video output of the home theater device responsive to the call video signals exchanged between the home theater device and the mobile communication device during a hands-free voice communication session between the home theater device and the wireless network.

33. The method of claim 28 further comprising receiving call initiation response signals from the mobile communication device via the short-range wireless transceiver responsive to user input at the mobile communication device, and controlling at least one of the audio output and the video output of the home theater device responsive to the received call initiation response signals.

34. The method of claim 33 further comprising continuing to control at least one of the audio output and the video output during a voice communication session between the mobile communication device and the wireless network.

35. The method of claim 33 wherein the controlling step comprises controlling at least one of the audio and video output of the home theater device by muting the home theater device, reducing the volume of the home theater device, pausing a program on the home theater device, or turning off the home theater device.

36. The method of claim 27 wherein the call control signals comprise call initiation requests generated responsive to user input.

37. The method of claim 36 wherein the call control signals comprise call progress signals received from the mobile communication device at the short-range wireless transceiver, and wherein the controlling step comprises controlling at least one of the audio output and the video output of the home theater device responsive to the received call progress signals.

38. The method of claim 36 wherein the user input comprises a phone number entered at an input device of the home theater device.

39. The method of claim 36 wherein the user input comprises a phone number entered at an input device of the mobile communication device and received at the short-range wireless transceiver of the home theater device.

40. The method of claim 36 wherein the user input comprises a phone number retrieved from a memory in one of the home theater device and the mobile communication device.

41. The method of claim 36 wherein the call signals comprise call audio signals, and wherein the controlling step comprises controlling at least one of the audio output and the video output of the home theater device responsive to the call audio signals exchanged between the home theater device and the mobile communication device during a hands-free voice communication session between the home theater device and the wireless network.

42. The method of claim 41 further comprising suppressing echo from a microphone input signal of the home theater device during the voice communication session.

43. The method of claim 36 wherein the call signals comprise call video signals, and wherein the controlling step comprises controlling at least one of the audio output and the video output of the home theater device responsive to the call video signals exchanged between the home theater device and the mobile communication device during a hands-free voice communication session between the home theater device and the wireless network.

44. A method of interfacing a mobile communication device in a wireless network with a home theater device, the method comprising:
detecting call signals at a long-range wireless transceiver of the mobile communication device; and
routing the call signals between the mobile communication device and the home theater device via a short-range wireless transceiver in the mobile communication device.

45. The method of claim 44 wherein the call signals comprise call audio signals, the method further comprising routing the call audio signals between the home theater device and the wireless network during a hands-free voice communication session between the home theater device and the wireless network.

46. The method of claim 44 wherein the call signals comprise call video signals, the method further comprising routing the call video signals between the home theater device and the wireless network during a hands-free voice communication session between the home theater device and the wireless network.

47. The method of claim 44 wherein the call signals include call control signals.

48. The method of claim 47 wherein the call control signals comprise a received call notification from the wireless network at the long-range wireless transceiver, and wherein the routing step comprises sending the received call notification to the home theater device via the short-range wireless transceiver.

49. The method of claim 48 wherein the call control signals comprise call initiation response signals received from the home theater device at the short-range wireless transceiver, the method further comprising:
establishing a hands-free voice communication session between the home theater device and the wireless network via the mobile communication device responsive to the call initiation response signals; and
routing the call signals between the wireless network and the home theater device over the short-range wireless interface during the hands-free voice communication session.

50. The method of claim 47 wherein the call control signals comprise call initiation request signals generated responsive to user input.

51. The method of claim 50 wherein the call control signals comprise call progress signals received from the wireless network at the long-range wireless transceiver, wherein the routing step comprises sending the call progress signals to the home theater device via the short-range wireless transceiver.

52. The method of claim 50 wherein the user input comprises a phone number entered at an input device of the home theater device.

53. The method of claim 50 wherein the user input comprises a phone number entered at an input device of the mobile communication device and received at the short-range wireless transceiver of the home theater device.

54. The method of claim 50 wherein the user input comprises a phone number retrieved from a memory in one of the home theater device and the mobile communication device.

55. The method of claim 50 wherein the call control signals comprise call initiation response signals received from the home theater device at the short-range wireless transceiver, the method further comprising:
establishing a voice communication session between the home theater device and the wireless network via the mobile communication device responsive to the call initiation response signals; and
routing the call signals between the wireless network and the home theater device over the short-range wireless interface during the voice communication session.
